(19) United States
(12) Patent Application Publication
(10) Pub. No.: US 2024/0224857 A9
(43) Pub. Date: Jul. 11, 2024

(54) GRAIN LOSS SENSING SYSTEM FOR A COMBINE HARVESTER

(71) Applicant: HCC, INC., Mendota, IL (US)

(72) Inventors: Jeffrey Harris Maney, Rockford, IL (US); John Joseph Gregorio, Chana, IL (US)

(21) Appl. No.: 18/368,707

(22) Filed: Sep. 15, 2023

Related U.S. Application Data
(60) Provisional application No. 63/418,160, filed on Oct. 21, 2022.

(51) Int. Cl. A01D 41/127

(52) U.S. Cl. CPC A01D 41/1273

(57) ABSTRACT

A grain loss sensing system for a combine harvester. The grain loss sensing system employs at least one emitter and receiver on the combine harvester and uses what is received by the receiver to calculate grain loss. The system can be configured to use, for example, microwave, ultraviolet, x-ray and/or photographic technology. The results are used to differentiate between grain and MOG. The results are relayed to the operator so that the operator can make adjustments and/or the combine harvester host controller receives this information and responds by making adjustments automatically.

### RELATED APPLICATION (PRIORITY CLAIM)

The present application claims the benefit of U.S. Provisional Application Ser. No. 63/418,160, filed Oct. 21, 2022, which is hereby incorporated by reference in its entirety.

### BACKGROUND

The present invention generally relates to grain loss sensing systems for combine harvesters, and more specifically relates to a novel and inventive grain loss sensing system for combine harvesters where the system utilizes at least one emitter and receiver to sense grain loss, using technology such as microwave, ultraviolet/infrared, x-ray or photography.

Combine harvesters are highly complex machines used to harvest many varieties of crops. Combine harvesters work to perform a multiple step harvesting process. FIG. 1 is a block diagram illustrating the different steps of a harvesting process typically performed by a combine harvester. As shown, a conventional harvesting process performed by a combine harvester includes the steps of cutting and gathering crop from the ground, threshing and separating grain from that crop for further processing, and then finally ejecting what is left over (often called “MOG” which is an acronym for “material-other-than-grain”) out the back of the machine. This process is never one hundred percent efficient, so inevitably some grain gets ejected out the back along with the MOG.

Ejecting grain out the back of a combine harvester effectively results in a loss of revenue. Depending on how inefficient the combine harvester was at separating out the grain before the ejection step, this loss could be quite significant. In an attempt to minimize or at least reduce this loss of revenue, oftentimes sensors are used to try to determine crop loss at various stages of the crop harvesting process. Based on what is sensed, one or more settings on the combine harvester are changed in order to try to increase the efficiency of the harvesting process and reduce the amount of grain that is ejected out the back of the machine.

One technology that is often implemented involves the use of a piezoelectric sensor. Specifically, the system relies on using the piezoelectric sensor to differentiate between the force of impact from MOG and the force of impact from grain. Since gain has a higher mass than MOG, the impact force is larger. However, there are so many variables in grain/MOG contents (e.g., volume, moisture, etc.) this results in piezoelectric sensors being not well suited to make precise measurements for grain loss. The technology is better suited to detect an increase or a decrease in grain loss, but is not very well suited with regard to accurately calculating loss rates (which loss changes frequently due to changing conditions in harvesting). Despite being unreliable in terms of accuracy, this technology (i.e., the use piezoelectric sensors to detect grain loss) has been employed for decades.

### SUMMARY

One object of an embodiment of the present invention is to provide a method of accurately measuring grain loss at the final stage of the harvesting process performed by a combine harvester.

Another object of an embodiment of the present invention is to employ microwave, ultraviolet/infrared, x-ray or photographic technology in a combine harvester to measure grain loss associated with the harvesting process being performed by the combine harvester.

Briefly, an embodiment of the present invention provides a grain loss sensing system for a combine harvester. The grain loss sensing system employs at least one emitter and receiver on the combine harvester and uses what is received by the receiver to calculate grain loss. Regarding what technology is employed by the system using the at least one emitter and receiver, the system can be configured to use, for example, microwave, ultraviolet/infrared, x-ray or photographic technology. Regardless, the results are electronically processed to differentiate between grain and MOG. Thereafter, these results are relayed to the operator so that the operator can make adjustments within the combine harvester (i.e., change the forward speed, change the fan speed, adjust the sieve opening, etc.) and/or the combine harvester host controller receives this information and responds by making adjustments automatically.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram illustrating the different steps of a harvesting process typically performed by a combine harvester;

FIG. 2 is a block diagram illustrating a grain loss sensing system being implemented in a combine harvester, where the grain loss sensing system is in accordance with an embodiment of the present invention;

FIG. 3 is a block diagram showing the grain loss sensing system of FIG. 2 in more detail;

FIG. 4 is an illustration which relates to the implementation of x-ray technology to sense grain loss; and

FIG. 5 is a block diagram showing the implementation of photographic technology to sense grain loss.

### DESCRIPTION

While this invention may be susceptible to embodiment in different forms, there are shown in the drawings and will be described herein in detail, specific embodiments with the understanding that the present disclosure is to be considered an exemplification of the principles of the invention and is not intended to limit the invention to that as illustrated.

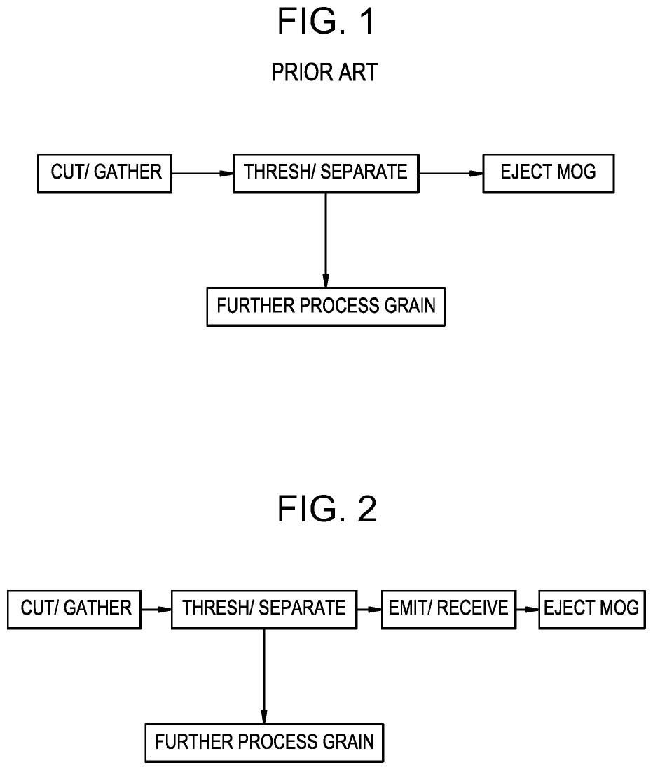

As discussed above, FIG. 1 illustrates the different steps of a conventional harvesting process performed by a combine harvester, and those steps include cutting and gathering crop from the ground, threshing and separating grain from that crop for further processing, and ejecting MOG.

FIG. 2 is a block diagram which illustrates a grain loss sensing system being implemented in that conventional harvesting process, where the grain loss sensing system is in accordance with an embodiment of the present invention. As shown, the system provides that a medium is emitted, and received, preferably at some point along the process between MOG being separated from the grain and that MOG being ejected from the back of the machine. Regarding what technology is employed by the system which involves emitting and receiving, the system can be configured to implement, for example, microwave, ultraviolet, x-ray or photographic technology. Regardless, the system differentiates between grain and MOG with regard to what is being emitted out the back of the machine.

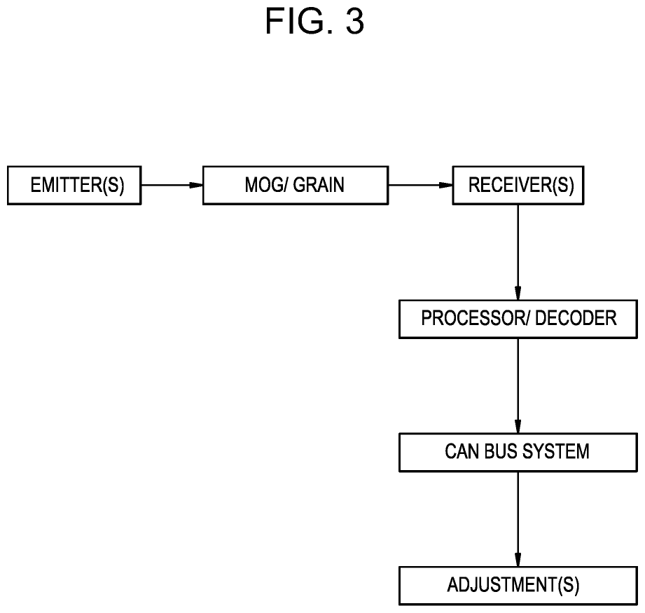

FIG. 3 is a block diagram showing the grain loss sensing system of FIG. 2 in more detail. As shown, the system provides that at least one emitter emits a medium through the MOG/grain that has been separated from the crop that was cut and gathered by the combine harvester, before that MOG/grain is ejected out the back of the machine. Both the at least one emitter and the at least one receiver can be mounted on side walls near the rear of the combine harvester. This will allow the sensor system to effectively “see” across the entire opening. However, it is also possible to mount the system 90 degrees, looking vertically though the material. In the grain loss measurement system incorporating photographic means, the sensing system may be mounted on only one side wall of the combine harvester.

As shown in FIG. 3, the at least one receiver sends information to a processor/decoder which processes/decodes that information and calculates grain loss. The decoding can be configured to provide results in various metrics, such as bushels per acre, tons per hour, etc. Regardless, that calculation is then sent to the CAN bus system of the combine harvester which uses that information to autonomously make one or more adjustments to the overall harvesting process and/or sends that information to an operator (such as via a display in the cab of the combine harvester) so that the operator can make one or more adjustments to the combine harvester regarding the harvesting process. Either way, the adjustments are effected to reduce the amount of grain that is ejected out the back on the machine, thereby reducing the loss of revenue.

With regard to what medium is emitted and received, the system can be configured to implement, for example, microwave, ultraviolet/infrared, x-ray and/or photographic technology.

For example, in the case of the implementation of microwave technology, each emitter would preferably be a high frequency oscillator that produces 3 to 300 GHz frequency radio waves. Each receiver would comprise a wave guide (such as a microwave focusing horn) and/or a lens coupled to a diode detector. Both the oscillator and the diode detector would ultimately be connected to the overall electronics of the combine harvester which controls the oscillator and receives signals from the diode detector.

In the case of the implementation of ultraviolet technology, each emitter would be an ultraviolet generator comprising an LED light source that produces wavelengths between 10 and 400 nanometers. Each detector would comprise an ultraviolet camera or photo diode. Both the ultraviolet generator and the ultraviolet camera would ultimately be connected to the overall electronics of the combine harvester. The electronics would control the LED light source and provide that the ultraviolet camera effectively “sees” the ultraviolet reflections of anything in view. The electronics compares these ultraviolet reflections to a full spectrum image, and the images are then mathematically rendered to determine features of objects in view. Each detector would comprise an ultraviolet camera or photo diode. Both the ultraviolet generator and the ultraviolet camera would ultimately be connected to the overall electronics of the combine harvester. The electronics would control the LED light source and provide that the ultraviolet camera effectively “sees” the ultraviolet reflections of anything in view. The electronics compares these ultraviolet reflections to a full spectrum image, and the images are then mathematically rendered to determine features of objects in view. In the case of the implementation of infrared technology, each emitter would be an infrared generator and the detector and electronics would use heat imaging.

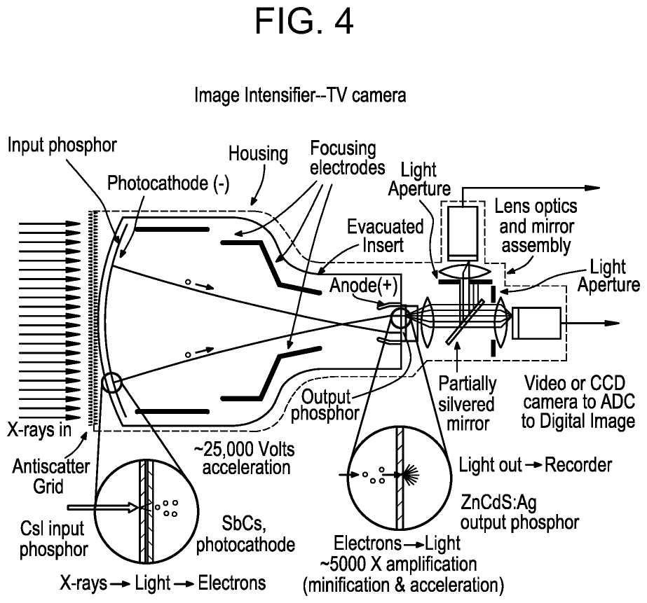

In the case of the implementation of x-ray technology, please see FIG. 4 which is self-explanatory. Each emitter would comprise an x-ray tube and a high voltage source, and each receiver would either be a flat panel with a scintillator (scintillators work by converting x-ray energy into visible light) that is coupled to a photo diode receiver (one per pixel), or a scintillator that is coupled to an image intensifier that transfers the light to a video camera or other light sensors. Both the emitter and receiver would ultimately be connected to the overall electronics of the combine harvester such that the electronics controls the high voltage source and receives signals from the receiver.

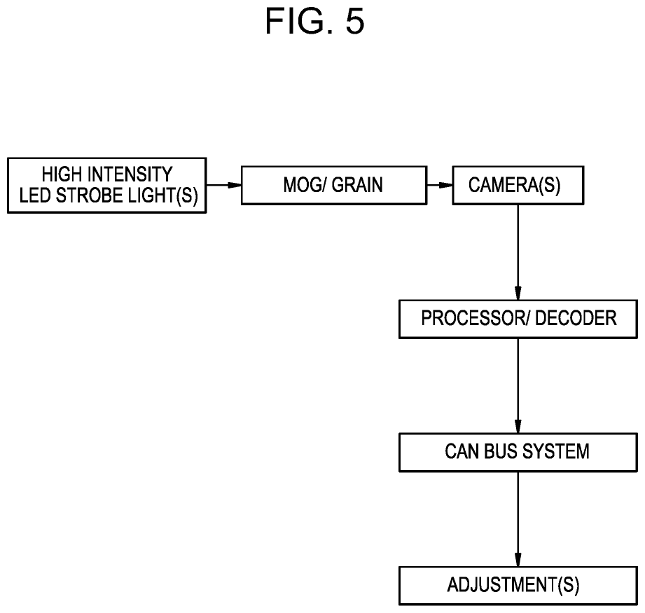

FIG. 5 is a block diagram showing the implementation of photographic technology to sense grain loss. Comparing FIG. 5 to FIG. 3, in the case of the implementation of photographic technology, the Emitter(s) identified in FIG. 3 comprise one or more high intensity LED strobe lights (shown in FIG. 5) and the Receiver(s) identified in FIG. 3 comprise one or more specifically designed cameras (shown in FIG. 5) to record images. The Processor/Decoder identified is configured to employ a series of algorithms to process images captured by the one or more cameras and calculate grain loss. Effectively, the embodiment depicted in FIG. 5 comprises a grain loss sensor specifically designed for a combine harvester that utilizes photographic means electronically to capture images for nearly real time analysis. An image capture software program provides for capturing desired images at specific rates (very high speed) and for specific durations (highly accurate image quality) to effectively “stop” the material within the combine when the images are electronically captured. The high intensity LED strobe lights are utilized to illuminate the field of view and electronically trigger the one or more specifically designed cameras to record the images. A series of algorithms are employed to have the processor analyze the images to determine grain volume and velocity within the mixture of grain and MOG traversing the cleaning shoe of the combine harvester. The algorithms determine the number of grains within a specific period of time, and by knowing the field of view for these images, highly accurate grain loss metrics are generated and constantly reported to the combine harvester operator. The operator can then make adjustments to the combine harvester systems to minimize grain loss for continuously changing field conditions during harvesting. Also, this sensor enables the combine harvester to autonomously adjust various systems within the machine to minimize grain loss in a closed loop system (if so designed).

Regardless of which technology is implemented, the system differentiates between grain and MOG with regard to what is being emitted out the back of the machine.

While specific embodiments of the invention have been shown and described, it is envisioned that those skilled in the art may devise various modifications without departing from the spirit and scope of the present invention.

What is claimed is:

1. A grain loss sensing system for a combine harvester, said grain loss sensing system comprising at least one emitter; at least one receiver; and a processor, wherein the processor uses what is received by the receiver to calculate grain loss.

2. A grain loss sensing system as recited in claim 1, wherein the system uses at least one of microwave, ultraviolet, x-ray and photographic technology to sense grain loss.

3. A grain loss sensing system as recited in claim 1, wherein the system is configured to relay results to an operator so that the operator can make adjustments.

4. A grain loss sensing system as recited in claim 1, wherein the system is configured to relay results to a combine harvester host controller which responds by making adjustments automatically.

5. A grain loss sensing system as recited in claim 1, wherein the at least one emitter comprises at least one strobe light, and wherein the at least one receiver comprises a camera.

6. A grain loss sensing system as recited in claim 5, wherein the at least one strobe light comprises at least one high intensity LED strobe light.

7. A grain loss sensing system as recited in claim 1, wherein the at least one emitter comprises an oscillator that produces radio waves, and wherein the at least one receiver comprises either a wave guide or a lens coupled to a diode detector.

8. A grain loss sensing system as recited in claim 1, wherein the at least one emitter comprises an ultraviolet generator comprising an LED light source that produces wavelengths between 10 and 400 nanometers, and wherein the at least one detector comprises either an ultraviolet camera or photo diode.

9. A grain loss sensing system as recited in claim 1, wherein the at least one emitter comprises an x-ray tube and a high voltage source.

10. A grain loss sensing system as recited in claim 9, wherein the at least one receiver comprises a flat panel with a scintillator that is coupled to a photo diode receiver.

11. A grain loss sensing system as recited in claim 9, wherein the at least one receiver comprises a scintillator coupled to an image intensifier that transfers light to a video camera or light sensor.

12. A method of sensing grain loss in a combine harvester, said method comprising: using a grain loss sensing system, said grain loss sensing system comprising at least one emitter, at least one receiver, and a processor, further comprising having the processor use what is received by the receiver to calculate grain loss.

13. A method as recited in claim 12, further comprising using at least one of microwave, ultraviolet, x-ray and photographic technology to sense grain loss.

14. A method as recited in claim 12, further comprising using at least one strobe light, and while using the at least one strobe light, using a camera to capture images.

15. A method as recited in claim 14, wherein the at least one strobe light comprises at least one high intensity LED strobe light.
